(19) United States
(12) Patent Application Publication
(10) Pub. No.: US 2009/0211320 A1
(43) Pub. Date: Aug. 27, 2009

(54) Electro-mechanical lock structure

(76) Inventor: Wen-Pin Wu, Gangshan Town (CN)

Correspondence Address: Muncy, Geissler, Olds & Lowe, PLLC, P.O. BOX 1364, FAIRFAX, VA, 22038-1364, US

(21) Appl. No.: 12/071,882

(22) Filed: Feb. 27, 2008

(51) Int. Cl. E05B 47/00

(52) U.S. Cl. 70/277

(57) ABSTRACT

An electromechanical lock structure includes a casing, an electric control mechanism and a manual member. The casing has a base and an accommodating space, the electric control mechanism is disposed within the accommodating space of the casing and has a first control switch, a rotation member corresponding to the first control switch, a drive member coupled to the rotation member, a clutch gear disposed between the rotation member and the drive member and a motor able to drive the clutch gear. The drive member has at least one protrusion, the clutch gear has at least one pushing block corresponding to the protrusion and the pushing block is capable of moving the protrusion. The manual control member has a knob and a spindle coupled to the knob, wherein the spindle penetrates the base of the casing and one end of the spindle is coupled to the rotation member of the electric control mechanism.

### FIELD OF THE INVENTION

This invention relates generally to a lock device, more particularly to an electromechanical lock structure capable of performing locking/unlocking operations with electric and manual control manners.

### BACKGROUND OF THE INVENTION

The electromechanical lock structure is known which mostly employs clutch mechanism to couple or isolate the power of electric and manual control for performing locking and unlocking functions by electric and manual control simultaneously, such as disclosed in R.O.C. Patent No. 479,725 entitled “electric lockset”. However, the electric lockset structure is poorly designed which operating unsmooth or mutual interference happens between electric and manual control operations causing great inconvenience for users.

### SUMMARY OF THE INVENTION

It is an object of this invention to provide an electromechanical lock structure that includes a casing, an electric control mechanism and a manual control member. The casing has a base and an accommodating space. The electric control mechanism is disposed within the accommodating space of the casing and includes a first control switch, a rotation member corresponding to the first control switch, a drive member coupled to the rotation member, a clutch gear disposed between the rotation member and the drive member and a motor able to drive the clutch gear. Wherein the drive member has at least one protrusion, the clutch gear has at least one pushing block which corresponds to and is capable of moving the protrusion, the manual control member has a knob and a spindle coupled to the knob, the spindle penetrates the base of the casing and one end of the spindle is coupled to the rotation member of the electric control mechanism. Due to the connection having excellent coordination among the clutch gear, the drive member and the rotation member in accordance with this invention, operating smooth for electric control and manual control may be enhanced substantially.

### DESCRIPTION OF THE DRAWINGS

FIG. 1 is a perspective exploded view of an electromechanical lock structure in accordance with a preferred embodiment of this invention.

FIG. 2 is a perspective assembly view of the electromechanical lock structure.

FIG. 3 is an assembly view of rotation member, clutch gear and drive member.

FIG. 4A to FIG. 4C is motion view of unlocking the electromechanical lock structure with manual control manner.

FIG. 5A to FIG. 5E is motion view of unlocking the electro-mechanical lock structure with electric control manner.

FIG. 6A to FIG. 6E is a portion of motion sectional view of unlocking the electromechanical lock structure with electric control manner.

### DETAILED DESCRIPTION OF THE INVENTION

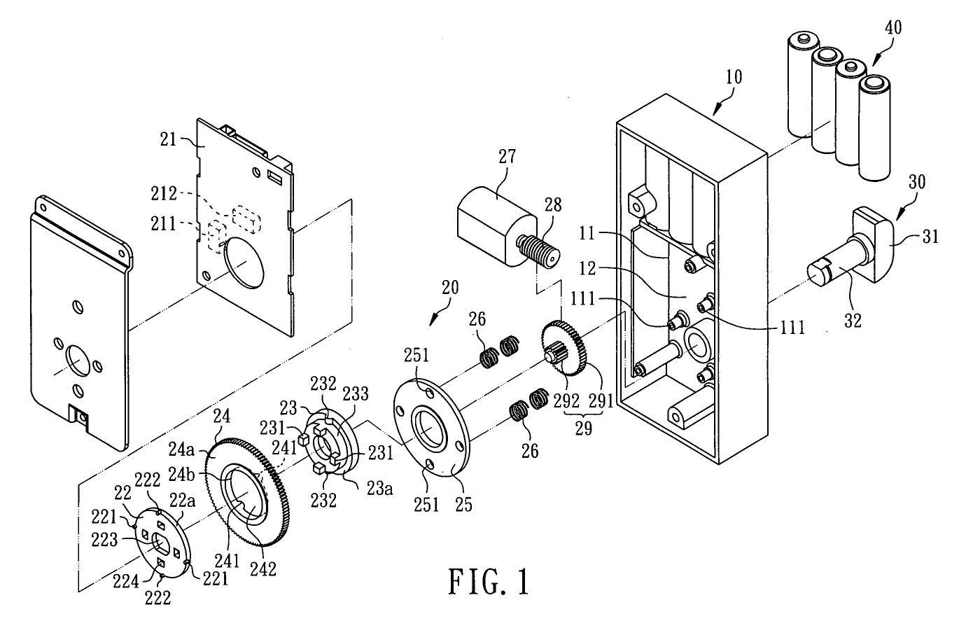

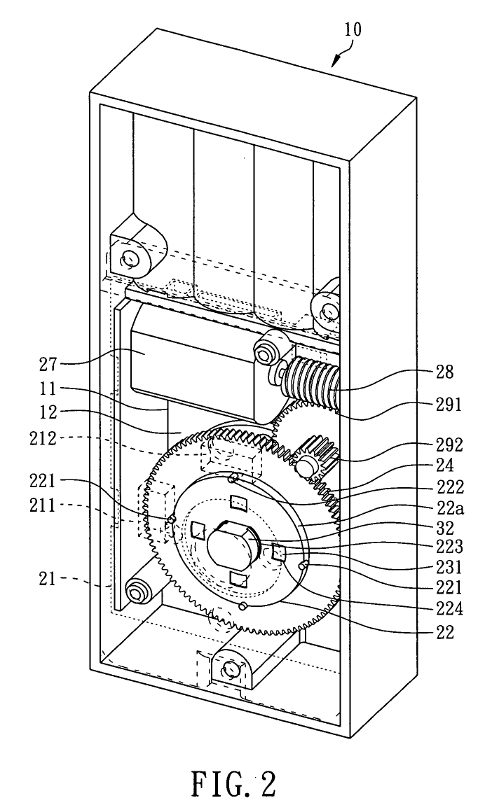

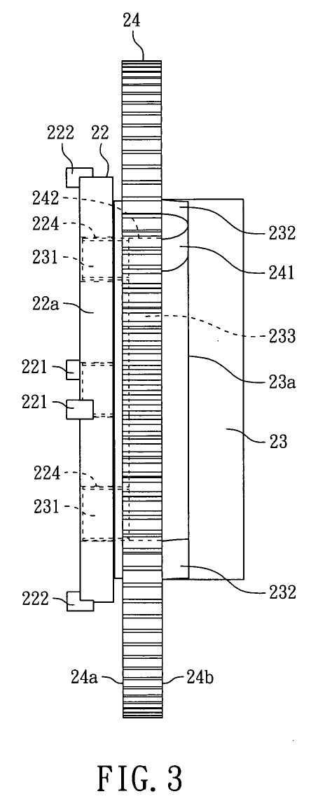

With reference to FIGS. 1 and 2 of the drawings, an electromechanical lock structure in accordance with a preferred embodiment of this invention includes a casing 10, an electric control mechanism 20, a manual control member 30 and a battery set 40. The casing 10 has a base 11 and an accommodating space 12. The electric control mechanism 20 which is disposed within the accommodating space 12 of the casing 10 includes a circuit board 21, a first control switch 211 and a second control switch 212 which are disposed on the circuit board 21, a rotation member 22 corresponding to the first control switch 211, a drive member 23 coupled to the rotation member 22, a clutch gear 24 disposed between the rotation member 22 and the drive member 23, a movable plate 25 contacted against the drive member23, at least one elastic member 26 pivotally disposed on the base 11, a motor 27 able to drive the clutch gear 24, a worm gear 28 disposed on the motor 27 and a double-layer gear 29. In this embodiment, a difference of disposition angle between the first control switch 211 and the second control switch 212 is 90 degree. The rotation member 22 has a peripheral wall 22a, at least one first projection 221 and at least one second projection 222 which protrude from the peripheral wall 22a, a central axis hole 223 and an engaging hole 224 formed at one side of the central axis hole 223. The first projection 221 corresponds to the first control switch 211 and the second projection 222 corresponds to the second control switch 212, wherein the first projection 221 and the second projection 222 may rotate either counterclockwise to respectively actuate the first control switch 211 or clockwise to respectively actuate the second control switch 212. The drive member 23 has a surface 23a facing the clutch gear 24, at least one connecting block 231 formed on the surface 23a, at least one protrusion 232 and a hollow cylinder 233 which protrude from the surface 23a. As shown in FIG. 1 and FIG. 3, the connecting block 231 of the drive member 23 is inserted into the engaging hole 224 of the rotation member 22 that allows the drive member 23 to be coupled to the rotation member 22 stably in this embodiment and preferably formed on the hollow cylinder 233. The clutch gear 24 has a first surface 24a facing the rotation member 22, a second surface 24b facing the drive member 23, at least one pushing block 241 protruding on the second surface 24b and an insertion hole 242 in communication with the first surface 24a and the second surface 24b. In this embodiment, the hollow cylinder 233 of the drive member 23 inserts into the insertion hole 242 and the pushing block 241 corresponds to the protrusion 232 of the drive member 23, wherein the pushing block 241 is capable of moving the protrusion 232.

Referring again to FIG. 1 and FIG. 2, the movable plate 25 has at least one through hole 251 that corresponds to the elastic member 26 and one end of the elastic member 26 contacts against the movable plate 25 in this embodiment. Preferably, the base 11 of the casing 10 has at least one positioning pillar 111 formed thereon and the elastic member 26 is disposed on the positioning pillar 111, one end of the positioning pillar 111 inserts into the through hole 251 of the movable plate 25. The motor 27 is electrically connected to the circuit board 21 and the double-layer gear 29 has a lower layer gear 291 and an upper layer gear 292 formed on the lower layer gear 291, wherein the lower layer gear 291 engages with the worm gear 28 and the upper layer gear 292 engages with the clutch gear 24. In this embodiment referring again to FIG. 1 and FIG. 2, the manual control member 30 has a knob 31 and a spindle 32 coupled to the knob 31, the spindle 32 penetrates the base 11 of the casing 10 and one end of the spindle is coupled to the rotation member 22 of the electric control mechanism 20 and preferably inserted into the central axis hole 223 of the rotation member 22. The battery set 40 is disposed within the accommodating space 12 of the casing 10 and electrically connected to the circuit board 21.

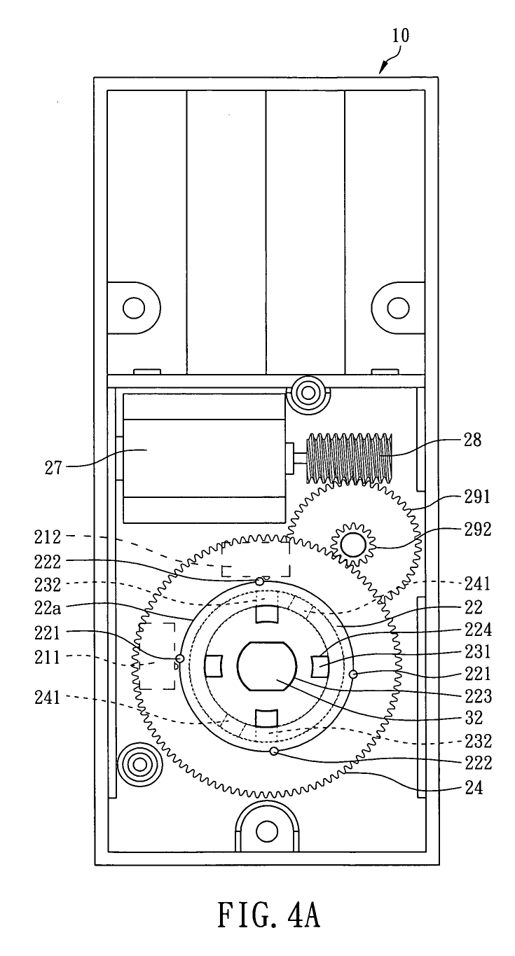

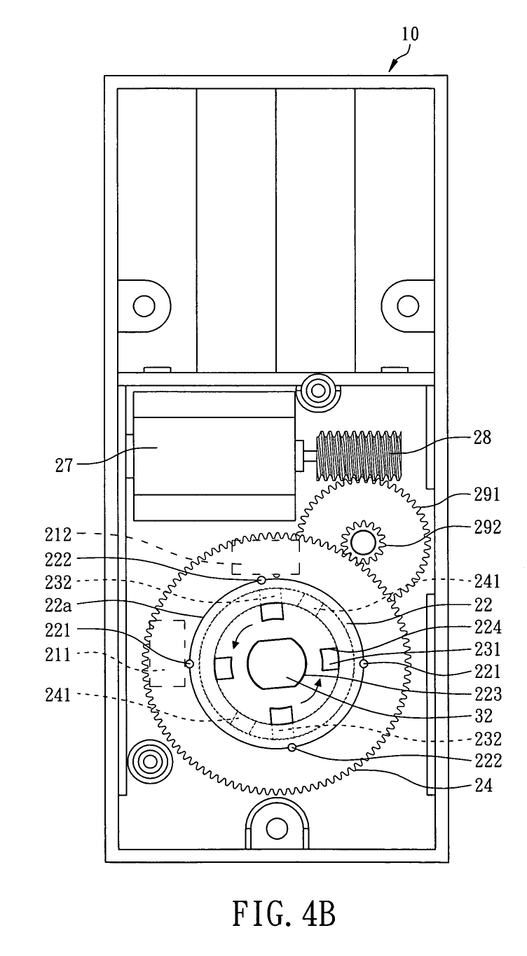

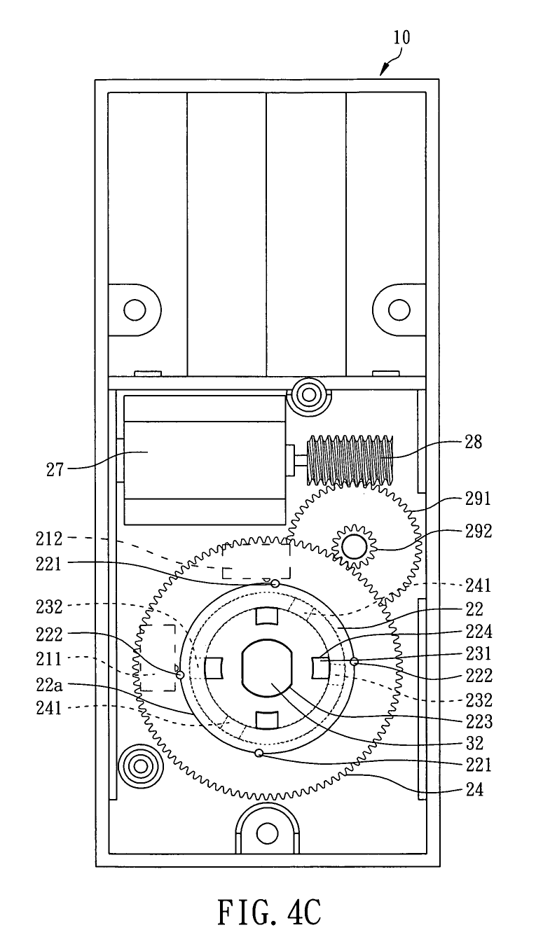

With reference to FIG. 4A to FIG. 4C, an action about that the electromechanical lock structure performs locking operation with manual control manner is shown. First, FIG. 4A shows elements of the electromechanical lock structure in unlocking position in which the first projection 221 of the rotation member 22 corresponds to the first control switch 211 and the second projection 222 corresponds to the second control switch 212. In this embodiment, if the electromechanical lock structure performs locking operation, it turns counterclockwise and applies the first control switch 211, otherwise in another embodiment, it may be modified to turn clockwise and apply the second control switch 211 instead of the first control switch 211. Next, referring to FIG. 4B, while rotating the manual control member 30 counterclockwise, the spindle 32 will drive the rotation member 22 and the drive member 23 to rotate and then the first projection 221 of the rotation member 22 will actuate the first control switch 211. In this embodiment, because of the connection between the manual control member 30 and a cylinder lock (not shown in the drawings), the manual control member 30 is designed to have a maximum turning angle 90°. Then referring to FIG. 4C, if the manual control member 30 is turned 90° counterclockwise, the second projection 222 of the rotation member 22 will actuate the first control switch 211 again to switch the electromechanical lock structure to locking position. Similarly, it merely needs to turn the manual control member 30 90° clockwise for switching the electromechanical lock structure to unlocking position with manual control manner.

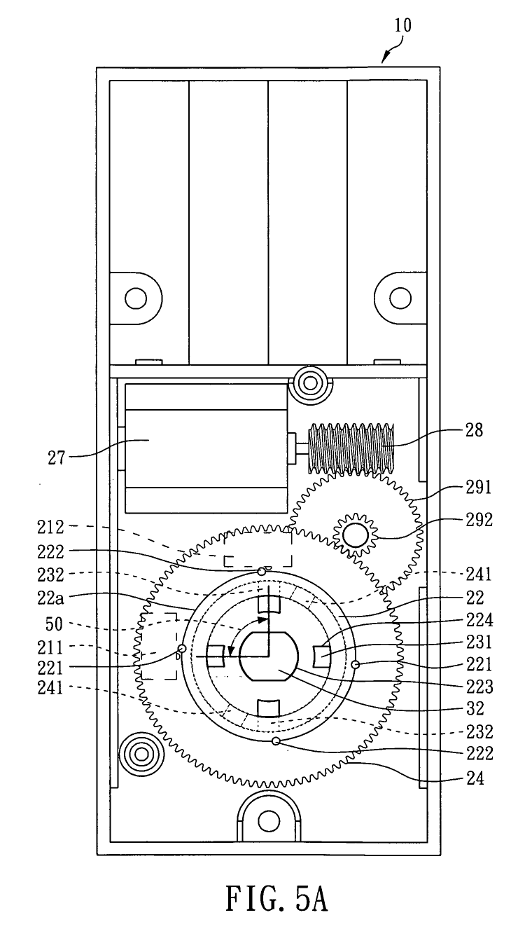

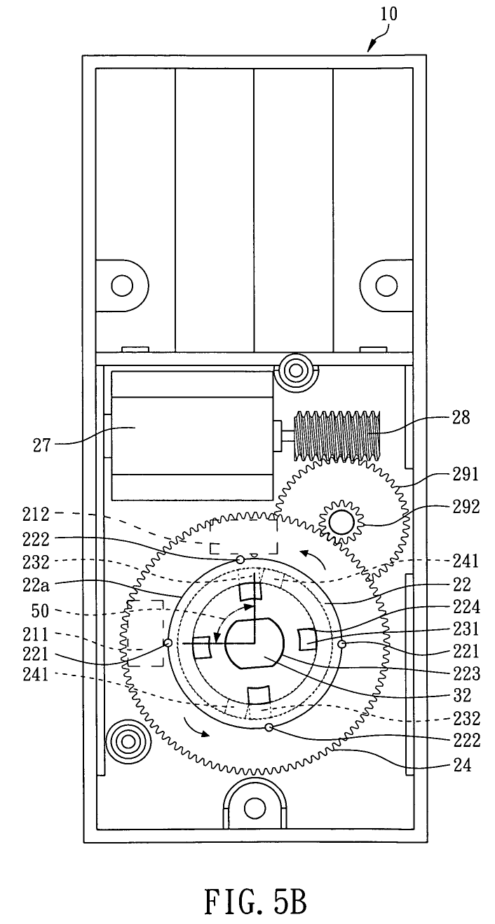

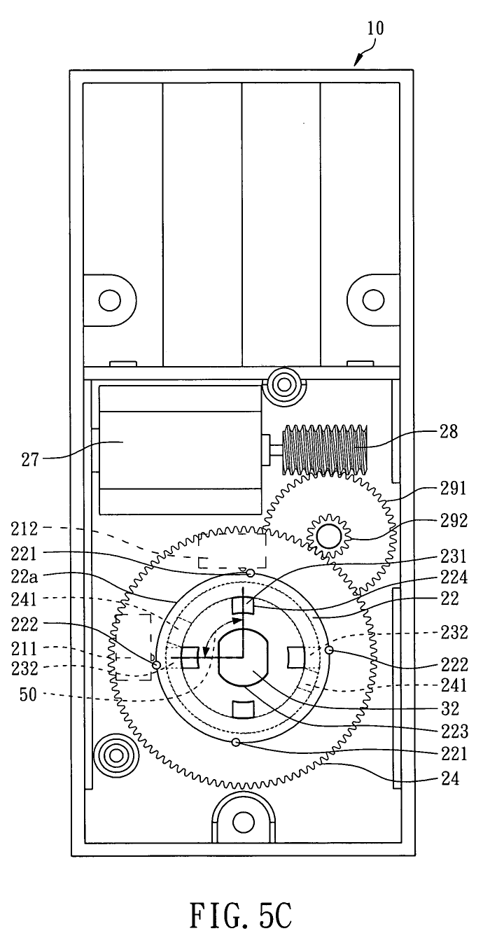

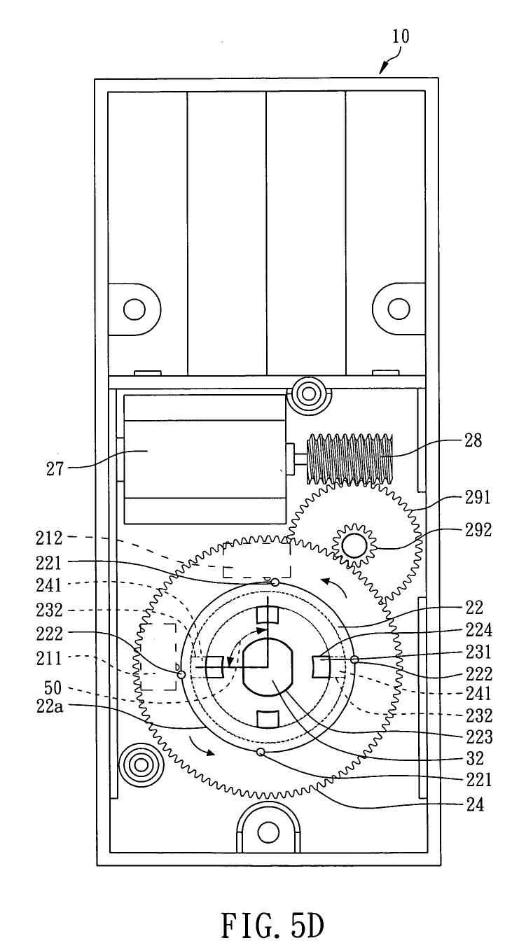

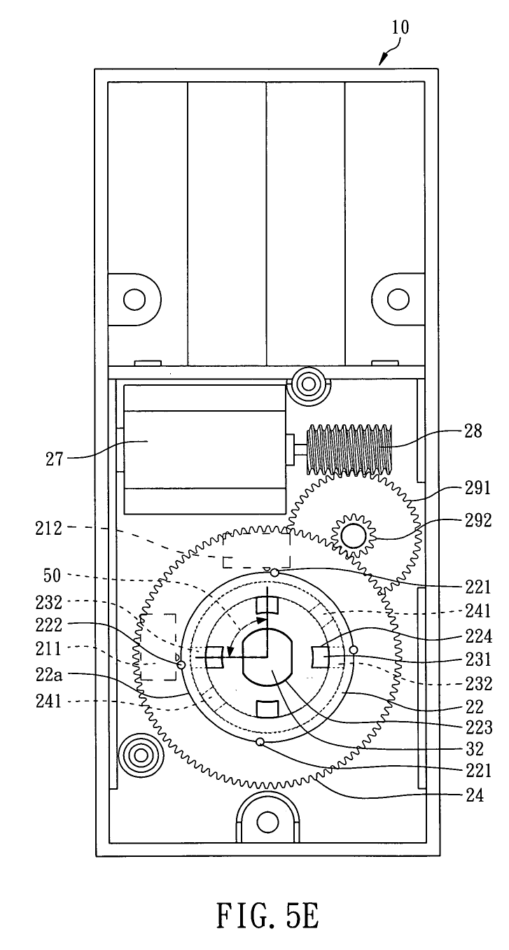

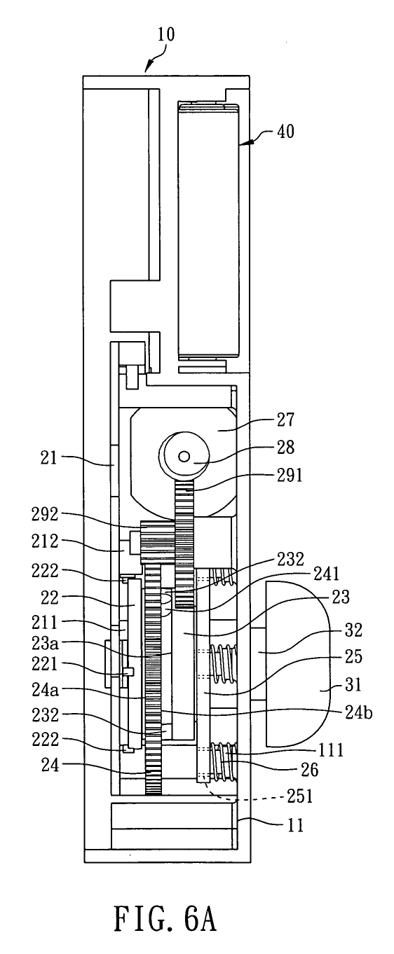

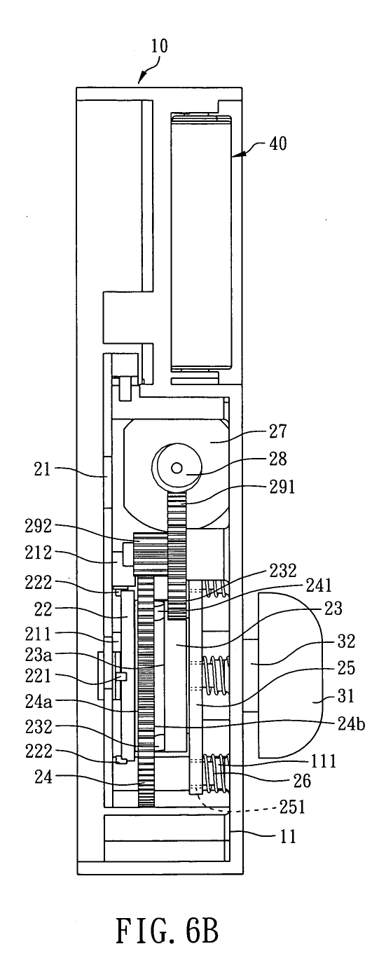

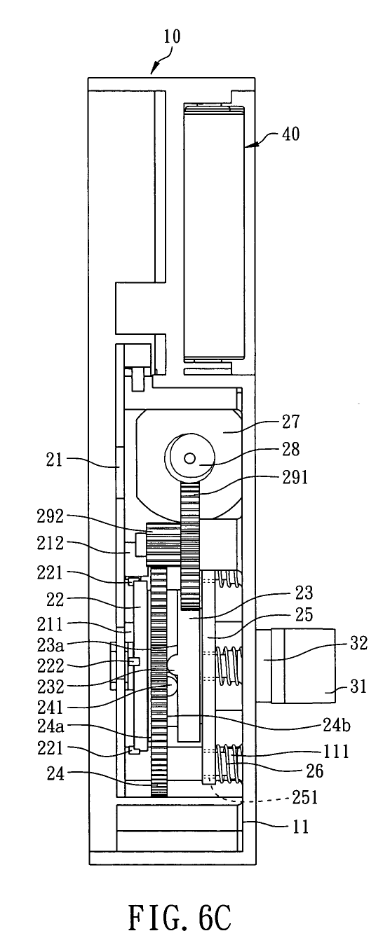

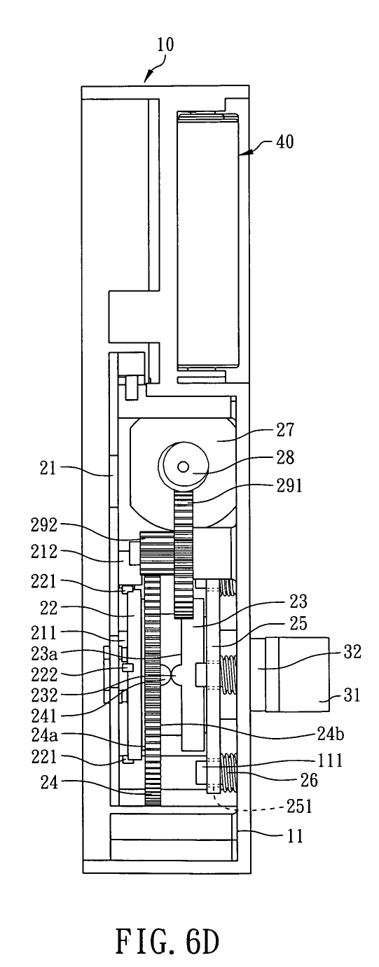

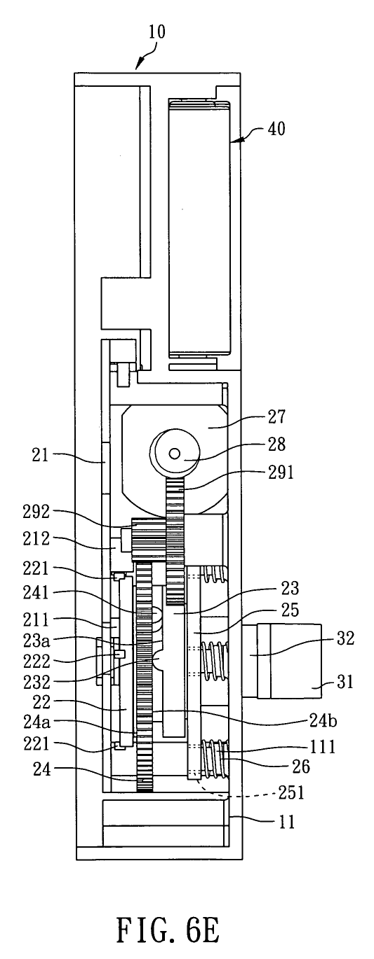

With reference to FIG. 5A to FIG. 5E and FIG. 6A to FIG. 6E, an action about that the electromechanical lock structure performs locking operation with electric control manner is shown. First FIGS. 5A and 6A show elements of the electromechanical lock structure in unlocking position in which the first projection 221 of the rotation member 22 corresponds to the first control switch 211 and the second projection 222 corresponds to the second control switch 212. The protrusion 232 of the drive member 23 defines a rotation range 50 and which is preferably limited within a 90° fan-shaped area. If the electromechanical lock structure is in unlocking position, then the pushing block 241 of the clutch gear 24 is located exterior to the rotation range 50 thereby preventing from mutual interference between electric and manual control operations. Besides, if the electromechanical lock structure performs locking operation in this embodiment, it turns counterclockwise and applies the first control switch 211, otherwise in another embodiment, it may be modified to turn clockwise and apply the second control switch 211 instead of the first control switch 211. Next, referring to FIG. 5B and FIG. 6B, while user utilizes a remote controller or a push member (both are not shown in the drawings) to actuate the electromechanical lock structure, the motor 27 will start to drive the worm gear 28 rotating and further drive the double-layer gear 29 and the clutch gear rotating that makes the pushing block 241 of the clutch gear 24 touch and push the protrusion 232 of the drive member 23 for rotating the drive member 23 and the rotation member 22. Meantime, the first projection 221 will actuate the first control switch 211. Because of the connection between the manual control member 30 and a cylinder lock (not shown in the drawings) in this embodiment, the manual control member 30 is designed to have a maximum turning angle 90°, similarly, the rotation member 22 which couples to the spindle 32 of the manual control member 30 still has a maximum turning angle 90° Then referring to FIG. 5C and FIG. 6C, if the rotation member 22 turns 90° counterclockwise, the first control switch 211 will be actuated again by the second projection 222 to switch the electromechanical lock structure to locking position. In this case, in order to allow the pushing block 241 of the clutch gear 24 to be located exterior to the rotation range 50 after performing locking operation, the motor 27 remains driving the clutch gear 24 rotating after the second projection 222 actuates the first control switch 211 until the pushing block 241 of the clutch gear 24 crosses the protrusion 232 of the drive member 23. Referring to FIG. 5D and FIG. 6D, while the pushing block 241 of the clutch gear 24 crosses the protrusion 232 of the drive member 23, the pushing block 241 will push the protrusion 232 allowing the drive member 23 and the movable plate 25 to move for the base 11 and compress the elastic member 26, meantime, the drive member 23 is able to make place for the pushing block 241 of the clutch gear 24 to smoothly cross the protrusion 232 of the drive member 23. Referring to FIG. 5E and FIG. 6E, while the pushing block 241 crosses the protrusion 232, the elastic member 26 will push the movable plate 25 for restoring the movable plate 25 and the drive member 23 and the motor 27 stops running immediately, the pushing block 241 is located exterior to the rotation range 50 at this time. While unlocking the electromechanical lock structure with manual control manner, an action of the manual control member 30 won't be interfered by the pushing block 241 of the clutch gear 24. Similarly, while the electromechanical lock structure is switched to unlocking position with electric control manner, the motor 27 drives the clutch gear 24 rotating clockwise and further drives the drive member 23 and the rotation member 22 rotating clockwise, and then the first and second projections 221, 222 of the rotation member 22 respectively actuate the first control switch 211 thereby switching to unlocking position. Therefore, due to the connection having excellent coordination among the clutch gear, the drive member and the rotation member in accordance with this invention, operating smooth for electric and manual control may be enhanced substantially.

What is claimed is:

1. An electromechanical lock structure including:
a casing having a base and an accommodating space;
an electric control mechanism disposed within the accommodating space of the casing and including a first control switch, a rotation member, a drive member which is coupled to the rotation member, a clutch gear which is disposed between the rotation member and the drive member and a motor which can drive the clutch gear, wherein the drive member has at least one protrusion, the clutch gear has at least one pushing block corresponding to the protrusion, and the pushing block is capable of moving the protrusion; and
a manual control member having a knob and a spindle coupled to the knob, wherein the spindle penetrates the base of the casing and one end of the spindle is coupled to the rotation member of the electric control mechanism.

2. The electromechanical lock structure in accordance with claim1, wherein the clutch gear has a first surface facing the rotation member and a second surface facing the drive member, the pushing block protrudes from the second surface.

3. The electromechanical lock structure in accordance with claim1, wherein the rotation member has a peripheral wall, at least one first projection and at least one second projection which protrude from the peripheral wall, the first projection corresponds to the first control switch.

4. The electromechanical lock structure in accordance with claim3, wherein the electric control mechanism further includes a second control switch corresponding to the second projection of the rotation member.

5. The electromechanical lock structure in accordance with claim4, wherein a difference of disposition angle between the first control switch and the second control switch is 90 degree.

6. The electromechanical lock structure in accordance with claim1, wherein the drive member has a surface facing the clutch gear and the protrusion protrudes from the surface.

7. The electromechanical lock structure in accordance with claim6, wherein the rotation member has at least one engaging hole, the drive member has at least one connecting block formed on the surface and the connecting block is inserted into the engaging hole.

8. The electro-mechanical lock structure in accordance with claim7, wherein the clutch gear has an insertion hole, the drive member has a hollow cylinder protruding from the surface and the hollow cylinder is inserted into the insertion hole of the clutch gear.

9. The electromechanical lock structure in accordance with claim8, wherein the connecting block of the drive member is formed on the hollow cylinder.

10. The electromechanical lock structure in accordance with claim7, wherein the rotation member has a central axis hole and the engaging hole is formed at one side of the central axis hole.

11. The electromechanical lock structure in accordance with claim10, wherein one end of the spindle of the manual control member is inserted into the central axis hole of the rotation member.

12. The electromechanical lock structure in accordance with claim1, wherein the electric control mechanism further includes a movable plate contacted against the drive member and at least one elastic member pivotally disposed on the base, one end of the elastic member is contacted against the movable plate.

13. The electromechanical lock structure in accordance with claim12, wherein the base of the casing has at least one positioning pillar formed thereon and the elastic member is disposed on the positioning pillar.

14. The electromechanical lock structure in accordance with claim13, wherein the movable plate has at least one through hole and one end of the positioning pillar inserts into the through hole of the movable plate.

15. The electromechanical lock structure in accordance with claim4, wherein the electric control mechanism further includes a circuit board, the first and second control switches are disposed on the circuit board and the motor is electrically connected to the circuit board.

16. The electromechanical lock structure in accordance with claim15, further comprising a battery set that is disposed within the accommodating space of the casing and electrically connected to the circuit board.

17. The electromechanical lock structure in accordance with claim1, wherein the electric control mechanism further includes a worm gear disposed on the motor.

18. The electromechanical lock structure in accordance with claim17, wherein the electric control mechanism further includes a double-layer gear which has a lower layer gear and an upper layer gear formed on the lower layer gear, the lower layer gear engages with the worm gear and the upper layer gear engages with the clutch gear.
